(19) United States
(12) Patent Application Publication
(10) Pub. No.: US 2019/0045281 A1
(43) Pub. Date: Feb. 7, 2019

(54) LOW POWER, HIGH REDUNDANCY POINT-TO-POINT TELEMETRY SYSTEM

(71) Applicant: Thomas Meek, Atlanta, GA (US)

(72) Inventor: Thomas Meek, Atlanta, GA (US)

(21) Appl. No.: 16/057,797

(22) Filed: Aug. 7, 2018

Related U.S. Application Data
(60) Provisional application No. 62/541,914, filed on Aug. 7, 2017.

(51) Int. Cl. H04Q 9/00

(52) U.S. Cl. CPC H04Q 9/00; H04Q 2209/50; H04Q 2209/60; H04Q 2209/40

(57) ABSTRACT

A low power, high redundancy point-to-point meter reading system, such as an automatic meter reading (AMR) system, that uses digital signal processing (DSP) techniques to make effective use of more (and potentially all) of the continual low-power data transmissions inherent in one-way data transmission systems by using multiple data transmissions to build a stronger, narrower band data transmission. For example, DSP techniques combining multiple low-power data samples into stronger signals can be used to lower the bandwidth required by the data collectors from the narrowband range (e.g., 30 kHz) down to the ultra-narrow frequency range (e.g., 7 kHz). Similarly, these DSP techniques may be used to increase the range of one-way meter systems in the 900 MHz ISM band. As another example, these DSP techniques may also be used to increase the sensitivity in the time domain rather than the frequency or code domain.

### TECHNICAL FIELD

The present invention pertains to radio telemetry, such as a point to multipoint meter reading system, particularly for the water industry. More precisely to a radio telemetry system utilizing repeat low power transmissions employed in mobile networks to enhance sensitivity for fixed networks. The primary business case here is implementation of fixed network AMI for existing RF enabled water meters.

### BACKGROUND

The problems presented by reading meters automatically are somewhat unique to the radio telemetry industry because of the particular challenges presented by automated meter reading (AMR). These techniques are applicable to simplex (one-way), babble mode or switched receiver duplex (two way) telemetry systems.

A radio receiver typically consumes less current than even a low power transmitter, being usually 2 milliamps for a well-designed receiver of the direct conversion type. This comprises a local oscillator and IQ down-convertor. Conversely a 10 milliwatt transmitter may consume 100 mA or so. 100 mW to 1 W transmitters which are also fairly common in existing mobile AMR installs consume several hundred milli-Amps from a nominal 3.7 volt supply. 100 mW one-way transmitters are the most common type of RF meters installed for mobile (i.e. van) meter reading to be found in the field and are most suited for the upgrade described in this patent. Itron part 15 non-spread spectrum devices are not part of this discussion which is only for spread spectrum devices requiring a battery.

When a one-way technique is employed for a walk by or drive by mobile meter reading system, the transmitter is necessarily pulsed with packets as short and as frequent as possible. This ensures successful transitional reception of drive by or walk by meter readings while minimizing battery drain. If a receiver and transmitter (2 way transponder) is used then the transmitter can be woken up by the receiver in response to a detection of a meter reader within range.

In most cases the receiver also needs to be pulsed on and off to conserve battery but to a lesser extent than a one-way transmitter as the receiver current consumption is less but not necessarily hugely less to render battery consumption techniques unnecessary. So for one-way systems continually pulsed radio transmissions for the most part are unused and contribute nothing but 900 MHz spectrum pollution on the ISM band. It can be argued that repeat transmissions will reduce radio fade, especially fast fading, but this is a secondary and fairly minor effect to improving radio range and reach. This patent describes a way to improve radio reception substantially by virtue of the repeat transmissions. It can be argued that transmissions now usefully to increasing range and opens new applications that meet the spirit of responsible use of the ISM to other users, as the whole idea of the ISM band is it depends on responsible and respectful use between users.

### SUMMARY

The invention may be realized in a low power, high redundancy point-to-point meter reading system, such as an automatic meter reading (AMR) system, that uses digital signal processing (DSP) techniques to make effective use of more (and potentially all) of the continual low-power data transmissions inherent in one-way data transmission systems by using multiple data transmissions to build a stronger, narrower band data transmission. For example, DSP techniques combining multiple low-power data samples into stronger signals can be used to lower the bandwidth required by the data collectors from the narrowband range (e.g., 30 kHz) down to the ultra-narrow frequency range (e.g., 7 kHz). Similarly, these DSP techniques may be used to increase the range of one-way meter systems in the 900 MHz ISM band. As another example, these DSP techniques may also be used to increase the sensitivity in the time domain rather than the frequency or code domain.

It will be understood that additional techniques and structures for low power, high redundancy point-to-point meter reading systems will become apparent from the following detailed description of the embodiments and the appended drawings and claims.

### BRIEF DESCRIPTION OF THE FIGURES

FIG. 1 is a conceptual illustration of an illustrative meter reading system including mobile and static meter reading units.

FIG. 2 is a conceptual illustration of data transmission in the illustrative meter reading system.

FIG. 3 is a conceptual illustration of data sampling in the illustrative meter reading system.

FIG. 4 is a conceptual illustration of a telemetry system using DSP techniques to increase the effective power of low power, redundant telemetry signals.

### DETAILED DESCRIPTION

Embodiments of the invention may be realized a low power, high redundancy point-to-point meter reading system that utilize an increase in real radio sensitivity by employing the repeat nature of one-way packets. It is fairly easy to understand that lower data rate will improve the range and sensitivity of a typical transmitter/receiver link, this is reflected in the Shannon principal. A lowering of the data rate increases the energy of each bit and narrows the receiver bandwidth necessary to interpret the bit stream. A traditional problem that effectively limits the narrowing of the bandwidth is the expense of the channel crystal to meet tight frequency tolerances necessary for ultra-narrow channel bandwidth. Use of digital signal processing (DSP) to provide multiple neighboring ultra-narrow channels loosens the demanding crystal tolerance requirement for one-way systems.

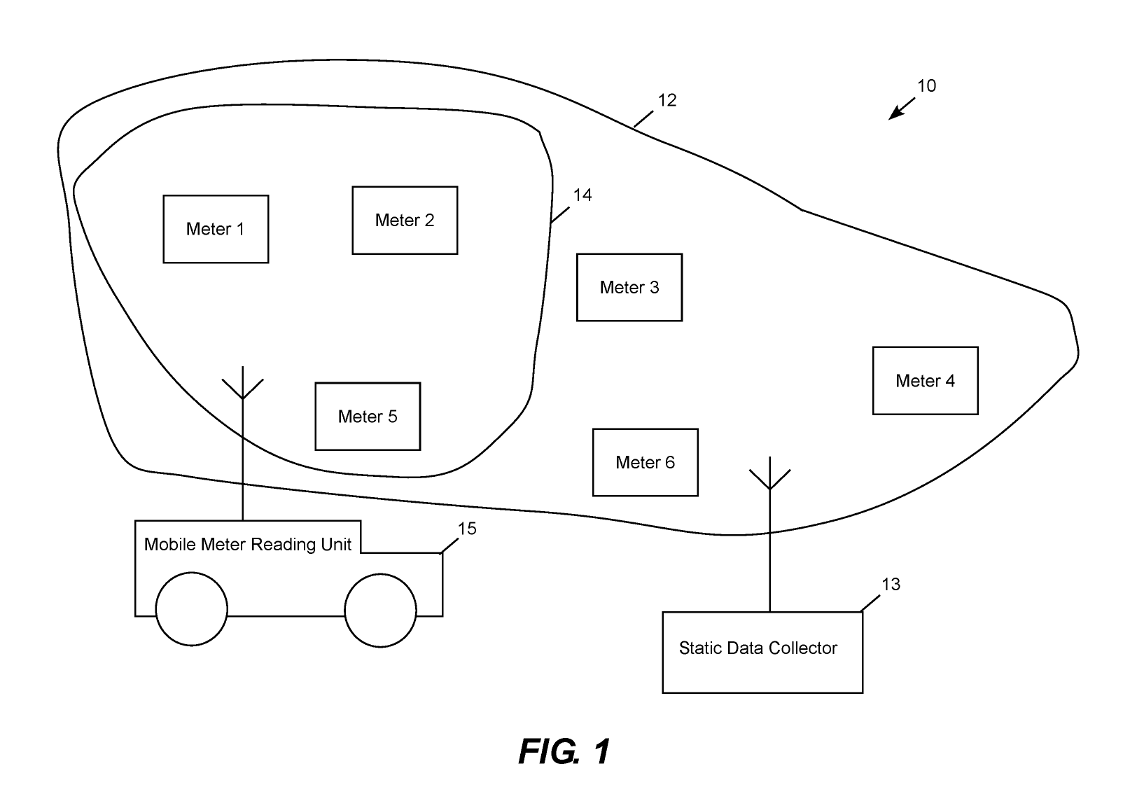

Meter reading systems are one example of the type of system that can benefit from this technology. FIG. 1 is a conceptual illustration of an illustrative meter reading system 10 including meters 1 through 6, where meters 1 through 6 are in an area 12 that can be read by a static data collector 13, while meters 1 through 3 are in an area 15 that can be read by a mobile meter reading unit 15 are including mobile and static meter reading units. The meter reading system 10 is an example of an embodiment of the present invention that facilitate the capture of wasted radio transmissions inherent to one-way meter transmissions. In the one-way system, the meters 1 through 6 continually transmit data regardless of whether a meter reading station, such as the static data collector 13 or the mobile meter reading unit 15 has requested or is ready to receive the data. This typically amounts to hundreds of wasted data transmissions per meter, per day. Environmentally conscious parties may object to this level of waste data transmissions inherent in conventional one-way meter reading systems. Even though the radio levels are well within acceptable power and exposure limitations, as with early cell phones, the amount of spectrum tolerated by these early models would certainly not be accepted today. And given the collaborative nature of governance of the ISM band required by the FCC, meter manufacturers not cooperating with the introduction of new techniques such as this, should be pressured to cooperate with technology designed to make better use of the band. The present invention uses digital signal processing (DSP) techniques to make effective use of more (and potentially all) of the continual low-power data transmissions inherent in one-way data transmission systems by using multiple data transmissions to build a stronger, narrower band data transmission.

For example, DSP techniques combining multiple low-power data samples into stronger signals can be used to lower the bandwidth required by the data collectors from the narrowband range (e.g., 30 kHz) down to the ultra-narrow frequency range (e.g., 7 kHz). Similarly, these DSP techniques may be used to increase the range of one-way meter systems in the 900 MHz ISM band. As another example, these DSP techniques may also be used to increase the sensitivity in the time domain rather than the frequency or code domain.

DSP techniques combining multiple low-power data samples into stronger signals require the receiver to synchronize onto a given packet to decode it and also predict the position of following packets through maximum likelihood techniques. The receiver may also derive a pattern through sliding windows (e.g., a one-bit synching window and one-bit matching window or more) and enhanced and rapid processing to sync onto a key sequence of patterns to hit on a sequence of packets that are re-transmitted continually. The receiver may also predict changes of packets and slight variations in repeat timing by a windowing technique to adjust bit timings for maximum signal to noise pickup.

For example, two packet changes may be utilized: (1) bits within the packet that are expected to change or change in an unpredicted way can be windowed out (e.g., if the CRC technique is unknown it is likely known which bits those are and they can be windowed out); and (2) bits changing in relation to meter consumption will increment in a predictable way between one reading attempt and the next or over 100 packets or so. One-way meter reading packets typically repeat every few seconds to 20 seconds. Over time, the pattern will increment once or more than once. The data collector can readily predict these alternate bit patterns.

As shown in FIG. 1 as an example, increasing the effective range and sensitivity of the one-way data transmissions makes meters 1 through 6 readable with the existing Static Data Collector 13, where it previously required the Mobile Meter Reading Unit 15 to travel in order to get close enough to read all of the meters. This can be very useful, for example, to extending the effective range and sensitivity of static data collectors on elevated infrastructures, such as buildings and towers.

In a typical system, 50 channel receivers leveraging use of DSP techniques may be employed so that all packets transmitted by all meters will be received by the associated data collector. Some packets will be lost due to random unslotted repeat times a bit like an ALOHA system. Missed packets will be dropped in the decoding scheme and the decoding will work on subsequent packets. The dropped packets may be monitored as a measurement of system performance and to indicate the need for system improvements.

Mixed two-way and one-way systems can also be collected by programming the two-way meters to transmit more frequently thus utilizing the same collection network to read them as well. DSP may be used to imitate the code of a particular type of meter, such as Neptune®, Itron®, Badger® or other, by recognizing the signature of each type of packet.

Telemetry systems often use very low bit rates and very narrowband receivers to achieve a long operating range from say remote switches in the middle of mountain ranges. Slowing down the rate of data packet transmission is quite simple. Because already installed meters don't have contiguous packets, however, a new firmware would need to be installed which is impractical for most deployed mobile radio meters. Another way of perceiving this is each bit has greater energy because of its extended length. This is quite a well known technique within the scope of modern DSP radio receivers. However, the perception that repeat non-contiguous transmissions might be usefully captured as a group of say 100 packets to potentially increase sensitivity by 20 dB is novel and is the subject matter for this patent application.

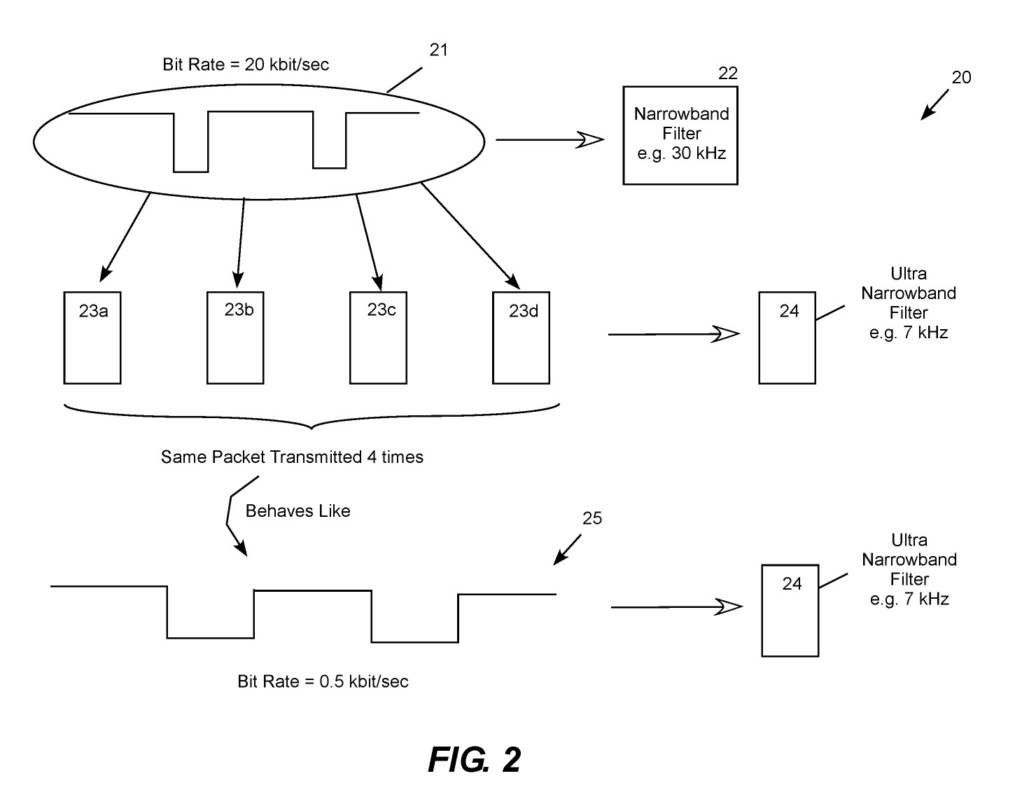

FIG. 2 is a conceptual illustration of data transmission 20 in an illustrative meter reading system. In this example, a low power data transmission signal 21 occurring at 20 kbit per second is received with a filter 33 operating at a narrowband frequency (e.g., 30 kHz). By repeating the transmission of the same packer 23a-d four times and using DSP to combine those signals so that an ultra-narrowband filter 24 (e.g., 7 kHz) can be used to receive the signal. This increases the effective sensitivity and range of the signal. In other words, the 20 kbit per second signal 21 where repeat packets are receives behaves like the slower 0.5 kbit per second signal 25, which can be received by the ultra-narrowband filter 24 (e.g., 7 kHz).

While four repeat packets are shown in FIG. 2 as an illustration, a practical meter reading system may use a larger number of repeat packets, for example in the range of 100 to 1,000 or more. Since a lot of one-way meters are already installed in the field and cannot be changed to transmit longer packets with increased bit energy, DSP receivers can be used to accumulate a number of packets, say 100 that repeat at an exact time and with the same sequence of bits and sync onto them coherently and exactly such that the energy of 100 bits can be constructively added to equal the energy of one packet with 100 times the length and a 1/100 data rate.

Using this technique to increase the effective sensitivity of one-way meter systems will produce a great marketing advantage to the beleaguered water utility that is faced with a tough choice of changing out all the water meters transponders from mobile to fixed (and in many cases from an unlicensed band to a much more expensive licensed band) to enable fixed operation for instance with tower mount collectors. Tower mount collectors are typically considered to be better suited to licensed band because of height introducing excessive and uncontrolled interference at the collector receiver in an unlicensed band. However, quite a few vendors do offer unlicensed “smart city” and related networks on the assumption this interference is manageable on say utility properties like water towers. Typically, few problems have been encountered with this type of install. Another case to look at with the ultra-narrowband for industrial, scientific and medical (ISM) use is the emergence of internet of things (IOT) standards and specifically long range wide area (LORAWAN) which relies on orthogonal frequency division multiplexing (OFDM) and long term evolution (LTE) style coding techniques to counter the effects of interference in the license free band.

The sensitivity improvement produced by the innovative techniques depends on repetition of the same packet at expected time and frequency slots. For instance, most currently installed one-way systems are known to have minimal security features in regard to the air interface that goes little beyond providing added redundancy codes (CRC) that are needed in any case for satisfactory error rejection on radio transmission of the packets. Packets will change according to consumption that will modify the CRC encoding. But this should be relatively trivial to decode for modern DSP based radio receivers. A note of interest is that the advanced collector design described here will help utilities retain older stock of RF enabled meters. More recent designs which rely more on two-way techniques and better encoding make it more difficult to predict the repeated bit patterns than those of the older systems. However, in an age of fast changing technology, utilities still hope to retain their communicating meters for over 20 years.

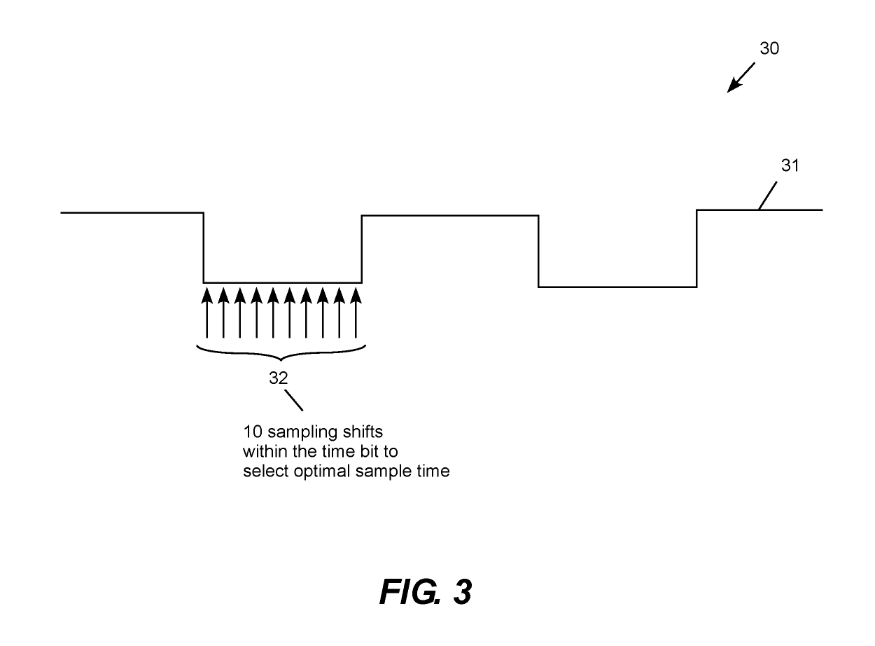

FIG. 3 is a conceptual illustration of data sampling 30 in the illustrative meter reading system. In this example, the data signal 31 is sampled with a number of sampling bits 32 within the associated time bit to select the optimal sample time. In this illustration, 10 sampling shifts are utilized. While 10 sampling shifts are shown in FIG. 3 as an illustration, a practical meter reading system may use a larger number of samples, for example in the range of 100 to 1,000 or more.

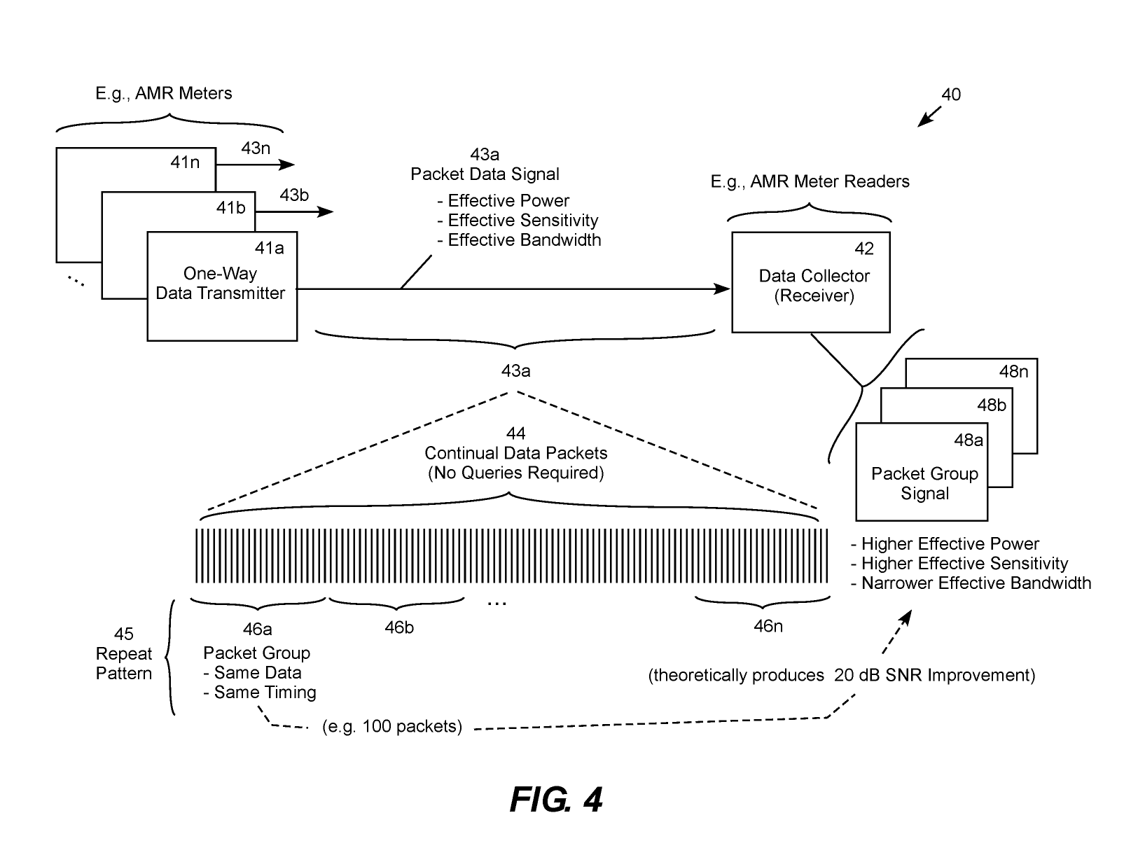

FIG. 4 is a conceptual illustration of a telemetry system 40 using DSP techniques to increase the effective power of low power, redundant telemetry signals, such as a typical automatic meter reading (AMR) system with one-way meters. The telemetry system 40 includes a large number of one-way data transmitters 41a-n, such as meters, communicating with a data collector (receiver) 42, such as an automatic meter reader. A practical AMS system may have thousands of meters and scores of data collection points. To use one data transmitter (e.g., meter) 41a to illustrate the procedure, the transmitter broadcasts a packet data signal 43a exhibiting an effective power, sensitivity and bandwidth. In this case, the power is typically very low, such as one Watt or less and bandwidth in the narrowband range, such as 30 kHz. The sensitivity, typically expressed in terms of the signal-to-noise ratio (SNR) depends on the noise in the particular location, but can be expected to be characteristically low due to the low level of the signal power.

The packet data signal 43a contains a large number of data packets that are transmitted continually without the need for queries from the receiver 42 or another requesting device. In other words, the data transmitter 41a continually spits out data packets in a one-way mode without receiving queries from another device. Typically, the data transmitter 41a is a one-way only (simplex) communication device that does not even have a receiver that would be necessary to allow it to engage in two-way (duplex) communications. This type of data transmitter 41a typically operates at a much higher data rate than the receiver 42. The packet data signal 43a sent by data transmitter 41a repeats packets with the same data. In other words, the packet data signal 43a forms a repeat pattern 45 that includes a series of packer groups 46a-n in which the packets forming each packet group contain the same data using the same timing.

For example, the data rate of the data transmitter 41a may be 100 times greater than the sampling rate of the data collector (receiver) 42, and each packet group may include 100 redundant packets containing the same data. In this case, 99% of the data packets transmitted by the data transmitter 41a are wasted in that they go unread by the receiver 42. While some of the data packets may be corrupted or lost in transmission, the wasted data packets—which represent wasted data transmission energy and wasted information—still approach 99% in the ordinary operation of a typical meter reading system.

The embodiments of the present invention take advantage of this data transmission energy and information that is wasted in conventional AMR systems by using DSP techniques to combine the redundant data packet in the packet group 46a to create a packet group signal 48a that has a higher effective power, higher effective sensitivity, and narrower effective bandwidth than the packet data signal 43a originally sent by the data transmitter 41a. Continuing with the example where each packet group 46a-n includes 100 repeat packets, the packet group signal 48a could theoretically experience a 20 dB (i.e., 100 times) improvement in the SNR over the packet data signal 43a originally sent by the data transmitter 41a.

In order to combine the repeat data packets of the packet data signal 43a to increase the power and sensitivity of the packet group signal 48a, the data collector 42 first detects the timing of the repeat pattern 45 so that it can sync up in order to receive and associate all (or most) of the repeat data packets in the each packet group 46a-n. Once the data collector 42 has collected all (or most) of the power associated with all (or most) of the packets in a particular packet group representing one data point, the data collector combines the power and information through DSP techniques. For example, the receiver 42 may retime the repeat packets up to 100 at a time to coherently add them in phase to increase their amplitude or strength to 100 times the power of the original packet. This is the time division equivalent to splitting one channel into multiple ultra-narrow channels to augment sensitivity in the frequency division multiplex (FDM) scenario. The resulting packet group signal has higher effective power, higher sensitivity, and lower bandwidth than the individual repeat data packets in the packet data signal 43a.

For the repeat packet data collection receiver to successfully capture the packets of a given meter it needs to pull the packet out of noise greater than the signal. To do this it needs to sync and correlate onto the start of a packet occurring randomly in time, which is effectively asynchronous. The receiver slides a window over the sampling packets time wise and attempts to synch onto a recognizable pattern over say 10 samples (in the example shown in FIG. 3) of the expected bit width and memorize the 10 noisy outputs. At the same time it slides another window or windows in similar fashion and in a fixed time derived from the expected packet window over the next 99 expected packets. The receiver then selects the best of the 10 slide windows and looks for repetition. Once found this will be correlated to extract the signal out of noise greater than the signal itself to realize sensitivity enhancement. Ideally the improvement will be at least 20 dB, but it could be less depending on the correlation efficiency and success in decoding expected possible packets changes, say 10 dB.

Since most frequency division automatic meter reading (AMR) systems use a fixed pattern common for every meter to transmit on 50 or more different frequencies, the receiver can find the next packet on the correct frequency slot as part of the decoding process. There is also the option in DSP to simulate the 50 main hop channels in addition to the time division sensitivity enhancement described above. Something similar can also be implemented for systems that use code division rather than 50+ way frequency hopping. In many systems, DSP is only used at the data collector themselves to accommodate older and installed meters so advanced and fast DSP techniques can be employed economically.

It should be appreciated that the bit stream that is transmitted on each packet is bit synchronous from one packet to the next. As a result, 10 shifts may be needed to achieve bit synchronization applicable from one packet to the next. This is likely to be true for most water AMR transponders as the bit timing is derived from suitable divisions from the main processor clock. In case it is not coherent in this sense, then considerably more memory storage may be required from the decoding receiver DSP.

It should also be appreciated that a well-known embodiment of one-way meters retransmits packets every 13 seconds. Since there are 24 hours in a day, there will be 100's of packets to choose from in the process of deriving improved signal-to-noise ratio (SNR). As a result, a 10-way shift of bit timing may not even be necessary in the case of incoherent bit streams on the packet from one packet to the next. A practical data sampling algorithm primarily needs to determine if each new packet it receives is helpful or hindering the SNR in the final DSP derived noise enhanced packet.

Another consideration is that rapid repeat of packets does undoubtedly improve Raleigh or fast fading but not so much for log normal fading. The option to use DSP unimproved packets could be used to gain initial SNR improvement to the signal, but in the long run the DSP improved signal is bound to win out. Simple propagation models would predict this result, and the improvement can be readily quantified through standard log normal and Raleigh fade statistics. Simple packet repeat with coherent power addition and SNR enhancement merely shortens the acquisition time. In a fixed network plenty of time and repetitions are available.

Another consideration, especially where the DSP improved result takes some time to derive, is what happens when the meter reading increments. Evidently the longer it takes to realize dB sensitivity improvement, the more likely the meter increments. Neptune® meters, for example, increment on 0.01 gallons of consumption. As a result, unless there are no leaks and no usage, it is likely that the meter could increment by several steps between each longer term DSP enhanced read.

There appear to be two approaches to the problem. One is to predict the bit pattern for each increment and test each case until the correct one is found. The other is to window out the parts of the packet expected to change, which applies in the case where synch has been achieved from the first stage DSP process. Meter packets are expected to be mostly meter identification (ID), preamble and maybe 30% meter read and cyclic redundancy check (CRC). The exact format of these packets will become known from spectrum analysis or the cooperation of the meter manufacturer. This will realize a 70% enhancement of the packet which is only 2 dB below the expected maximum enhancement, so pretty good. Add to that the only part of the meter read expected to change will be the least significant bit (LSB) part and the picture for getting satisfactory sensitivity enhancement looks good. Overall, embodiments of the invention are expected to achieve the meter increment of 20 dB in most cases, although design refinement and performance monitoring may be required at the implementation stage.

Another consideration is that the present trend with even water AMR is to move from one-way to two-way systems, and to also move to a higher power, such as one watt implying less redundant packets. Embodiments of the invention may therefore be more suited to presently installed AMR systems until they are eventually replaced by two-way meters when the typical 20 year life span of present meter reading system is reached. As a result, deploying embodiments of the invention may occur on timescales based on the expected life and system upgrade needs considered on an utility-by-utility basis. It is known, for example, that Neptune® one-way AMR systems have been deployed continually over the past 15 years but other companies such as Itron® and others may have a preponderance of meter transponders 10 to 20 years old that are one-way and low power and a certain percentage of two-way modern transponders that are zero to 10 years old.

When making the upgrade decision, it may be important to consider whether and how a proposed upgrade to two-way ASR system will improve the link budget, as it is not obvious that two-way actually extends range. The link budget may not improve significantly, for example, if the meter already transmits one Watt (the typical regulatory power limit). In many cases, an upgrade to a two-way ASR system may not provide the 20 dB or more improvement in the link budget that may be achieved through the use of DSP repeat packet techniques described in this specification. In fact, in some cases an upgrade to a two-way AMR system may has no significant improvement in terms of link budget over a DSP improvement to the one-way AMR system, and could even be less if battery consumption needs to be preserved.

The main contenders for AMR vendors of likely to benefit the most from this DSP-type of upgrade to an existing one-way AMR meters are the ones with the most one-way equipment installed in the field, which is thought be Neptune®, Itron® and Badger® (to a lesser extent). The typical pattern of each meter type will be a known signature and the use of DSP to interpret the typical pattern for each type of meter. Research needs to be done on bit timings for each meter type since that is critical to the memory requirements and complexity of the DSP decode. It is considered likely that since most transmitters operate off divisions of a single reference crystal, the timings will be derived by simple methods typical of first stage AMR/AMI.

Itron® meters are known to use one-way babble even in their nominal two-way equipment presently marketed so stand to be the biggest beneficiary from DSP-type of upgrade to their existing one-way AMR meters. In fact, Itron is believed to have 75 million electric water and gas meters with a one-way AMR capability already installed. However, this is thought to be mostly (perhaps three-quarters) so called encoded receiver-transmitters (ERTs) which don't use crystal control, but instead use a “hot carrier diode” to spread transmissions across the unlicensed band. Presently, innovative DSP techniques are believed to be best suited to devices with crystal control and relatively little short term drift. It is estimated that three-quarters of the more recent products actually are crystal controlled, which represents a significant potential market.

In view of the foregoing, it will be appreciated that present invention provides significant improvements to low power, high redundancy point-to-point meter reading systems. The foregoing relates only to the exemplary embodiments of the present invention, and that numerous changes may be made therein without departing from the spirit and scope of the invention as defined by the following claims.

The invention claimed is:

1. A low power, high redundancy point-to-point telemetry system, comprising:
a plurality of one-way data transmitters, each configured to transmit a packet data signal comprising continual data packets transmitted without relying on queries from another device to trigger transmission of the data packets;
wherein each packet data signal comprises a series of packet groups defining a repeat pattern in which each packet group comprises a series of repeat packets containing the same data;
wherein each data packet has an effective power; and
a data collector configured, for each packet data signal, to receive the packet data signal, detect repeat pattern associated with the packet data signal, and to build a series of packet group signals using the repeat pattern to combine the repeat packets of each packet group;
wherein each packet group signal exhibits a higher effective power than the effective power of the individual repeat packets forming the packet group signal.

2. The telemetry system of claim 1, wherein the packet group signals exhibit a higher effective sensitivity than the packet data signals.

3. The telemetry system of claim 1, wherein the packet group signals exhibit a narrower effective bandwidth than the packet data signals.

4. The telemetry system of claim 1, wherein the data transmitters comprise meters and the data collectors comprise meter readers.
